(19) United States
(12) Patent Application Publication
(10) Pub. No.: US 2009/0161893 A1
(43) Pub. Date: Jun. 25, 2009

(54) HANDHELD TRANSMITTER/RECEIVER

(75) Inventors: Yasuhiro Hironaka, Osaka (JP); Senji Adachi, Tokyo (JP); Futoru Nagayama, Tokyo (JP)

Correspondence Address: LOWE HAUPTMAN HAM & BERNER, LLP, 1700 DIAGONAL ROAD, SUITE 300, ALEXANDRIA, VA, 22314, US

(73) Assignee: YOUNG Co., Ltd., Osaka-shi (JP)

(21) Appl. No.: 12/094,150

(22) PCT Filed: Nov. 16, 2006
(86) PCT No.: PCT/JP2006/322897

§ 371 Date: May 17, 2008

(30) Foreign Application Priority Data
Nov. 17, 2005 (JP) 2005-333331

(51) Int. Cl. H04R 25/00

(52) U.S. Cl. 381/151

(57) ABSTRACT

It is intended to provide a handset that can communicate clear conversations and that is superior in serviceability, even in work environments where wearing a helmet is required or in conditions where wearing a helmet or mask is required, such as when riding a two-wheel vehicle, performing construction work, or the like, and that includes a bone conduction speaker and a laryngophone that are detachable. The handset includes a bone conduction speaker 1 that uses a ceramic piezo element for transmitting a voice by utilizing a bone conduction sound, a laryngophone 2 that uses a ceramic piezo element for picking up voice vibrations around a throat, and connecting equipment 10n that detachably connects said bone conduction speaker and said laryngophone that processes signals, and that is provided with a transmission line that transmits signals sent and received for calls.

### CROSS-REFERENCE TO RELATED APPLICATIONS

The present Application is based on International Application No. PCT/JP2006/322897, filed on Nov. 16, 2006, which in turn corresponds to Application No. JP2005-333331 filed on Nov. 17, 2005, and priority is hereby claimed under 35 USC § 119 based on these applications. Each of these applications are hereby incorporated by reference in their entirety into the present application.

### TECHNICAL FIELD

The present invention relates to a handset to allow conversations to be conducted by using a bone conduction speaker and a laryngophone in noisy conditions when it is not possible to use air conduction sound or in an environment where wearing masks or the like is required.

### BACKGROUND ART

There are cases where conversations using so-called air conduction sound by air transmission cannot be conducted, such as when using earplugs to reduce construction noise and to prevent hearing loss, while wearing a helmet at a construction site, when wearing a full-face helmet while riding a two-wheel vehicle, or when wearing a dust mask. For this reason, a bone conduction speaker, which enhances one's hearing ability just by being placed in close contact with one's head in the vicinity of the ears, is known and sometimes used on such occasions as when wearing a helmet and the like. Also, on such occasions as when surrounded by noises at a construction site or when wearing a mask, one can use a laryngophone, which picks up voice vibrations, placing it in close contact with one's throat or neck. Communication systems for conducting conversations using this kind of device are sometimes used.

Examples of a device that combines a bone conduction speaker and a laryngophone include the handset of Patent Document 1. In this example, a bone conduction speaker and a laryngophone are housed in a compartment that is provided on a support made of flexible tape so as to be able to be affixed closely at a desired location by a pressure-sensitive adhesive sheet that hangs from one's ear to one's neck or that is fitted by using an ear piece. Examples of a device mounting a bone conduction speaker on a helmet include that of Patent Document 2, that in part says: “a speaker having a helmet as a component or a helmet having a speaker function.” In this example, the driving unit of the bone conduction speaker closely contacts the outside surface of helmet's hat body in the vicinity of an ear, and the vibrations of the driving unit are directly transferred to the hat body, causing the hat body to vibrate, which enables the hat body to act as the vibrating plate of a speaker, and accordingly the voice is transmitted to the user by resonant reflection in the hat body.

Patent Document 1: Unexamined-Patent Publication No. 2002-359889

Patent Document 2: Unexamined-Patent Publication No. 2001-333478

Patent Document 1 intends to enable conversations in a working environment as described above, by using a bone conduction speaker and a laryngophone; however, in a configuration using a common coil-type speaker and a condenser microphone, the use of a bone conduction speaker or a laryngophone might not provide clear voices and/or other sounds and/or might pick up peripheral sounds, due to those devices' respective frequency characteristics, type of antenna used, and the like when reproducing sounds by a speaker or acquiring sounds by a microphone. Therefore, such a configuration is not suitable, although Patent Document 1 does not refer to the characteristics of a speaker and a microphone in these regards. Also, in a configuration using a pressure-sensitive adhesive sheet or the like for attaching a device, the sense of use or serviceability is far from satisfactory, because a pressure-sensitive adhesive sheet does not feel good and a sheet can be used only one time and must be replaced every time that a sheet is to be used.

Moreover, with the invention of Patent Document 2, an efficient bone conduction speaker is configured by mounting the driving unit of a bone conduction speaker on one side of a helmet in such a way as to directly vibrate the helmet's hat body, reducing the danger of the user being unable to hear sounds around the user because the user's ears are plugged, as when using earphones. However, improvement of a speaker alone cannot solve the above-mentioned problems and, moreover, such an approach has a problem in that it causes difficulties in conversations as a result of picking up sounds in the user's environment if in such heavy work environments as fire-fighting, shipbuilding, stonecutting, welding, working in a tunnel, working at a construction site, road-construction work, working in a manhole or the like, or while riding a two-wheel vehicle like a motorcycle, because the microphone is a normal one that uses air conduction sound. Moreover, the problems are intensified further if a user is wearing a mask. Furthermore, in order to configure a helmet's hat body as a vibrating plate, the vibrating plate must be adhered to or mechanically fixed on the hat body, and therefore it is not possible to easily change the bone conduction speaker or the like or to use the helmet alone by removing the vibrating plate, resulting in problems in serviceability and ease of use.

### SUMMARY OF THE INVENTION

Consequently, one aspect of the present invention is to provide a handset that (1) allows a bone conduction speaker and a laryngophone to be removable, (2) produces clear sounds and clear conversations without picking up unnecessary ambient noises as peripheral rumbling sounds when in an environment where wearing a helmet or a mask is required, such as when riding a two-wheel vehicle like a motorcycle, or when working outdoors, as in a manhole, and (3) is easily removable and superior in serviceability.

In one aspect of the present invention a bone conduction speaker uses (1) a ceramic piezo element for transmitting a voice by utilizing bone conduction sound, (2) a laryngophone that uses a ceramic piezo element for picking up voice vibrations around a user's throat, and (3) connecting equipment that detachably connects the bone conduction speaker and the laryngophone, processes signals, and includes a transmission line that transmits signals that are sent and received for calls.

In another aspect of the invention, the bone conduction speaker and the laryngophone use PZT (piezo element) ceramic material and have a waterproof constitution that satisfies either the International Protection Code (IP Code) waterproof standard as set forth in JIS C0920 (Degrees of protection provided by enclosures) or the standard of IEC (International Electrotechnical Commission) 529 (Degrees of protection by enclosures).

In another aspect of the invention, the connecting equipment is provided with (1) a sound-level control unit that amplifies and adjusts the level of signals of the laryngophone, (2) a frequency-compensation circuit that defines the transmission-frequency characteristics of signals, (3) an output buffer amplifier that connects with the voice-input unit of a communication system that has external connections, (4) an input buffer amplifier that connects with the voice-output unit of the communication system, (5) an impedance-matching reproduction circuit that achieves impedance matching along with outputting reproduced voice signals to the bone conduction speaker, and (6) a feedback-control circuit that detects the level of voice signals so as to obtain the appropriate signal level.

In another aspect of the invention, the bone conduction speaker is detachably contained in a sack-like portion that is in the inner cap of a helmet and that is mounted between the head of a user and the inner wall of the helmet, or is detachably mounted on an inner protection band of the helmet by a fastener that is provided on the bone conduction speaker, and the laryngophone is detachably contained in a sack-like portion on the support belt of the helmet or is detachably mounted on the support belt by a fastener that is on the laryngophone.

In another aspect of the invention, the invention is characterized such that the sending and receiving of signals between the connecting equipment and the communication system are executed by wireless communications that use light-wave transmission by infrared communication or that use electromagnetic waves.

In another aspect of the invention, the invention is characterized such that the connecting equipment is integrally incorporated into the communication system.

In another aspect of the invention, the connecting equipment is provided with a rechargeable secondary battery that supplies power to an internal circuit of the connecting equipment and that is rechargeable by a power source that supplies power through a transmission cable that is connected to the communication system or by a power source that supplies power from externally connected charging equipment.

In another aspect of the invention, the aforementioned support belt is provided with a foam buffer sheet that blocks or attenuates acoustic transmission between the helmet and the aforementioned sack-like portion that contains the laryngophone.

In another aspect of the invention, the bone conduction speaker is attached to a display panel and is used as a speaker to vibrate the display panel.

### EFFECTS OF THE INVENTION

According to the present invention, clear conversations in noisy environments can be conducted by using a handset provided with a bone conduction speaker and a laryngophone. Good serviceability is provided by enabling both the bone conduction speaker and the laryngophone to be removable when mounting them on a helmet, due to their being easy to remove and replace. Moreover the small size and low weight of the present invention gives a user a good feeling when fitting and using the handset. Furthermore, because this handset provides for wireless communication between the connecting equipment and communication systems, it is suitable for use at or in a wider range of work environments, such as construction sites and the like.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTIONS OF THE DRAWINGS

The present invention is illustrated by way of example, and not by limitation, in the figures of the accompanying drawings, wherein elements having the same reference numeral designations represent like elements throughout and wherein:

FIG. 1 presents structural views of the connecting equipment of the handset of one embodiment of the present invention; (a) is a cross-sectional view from the front and (b) is a cross-sectional view from the right side.

FIG. 2 presents external views of the connecting equipment shown in FIG. 1; (a) is a left-side view, (b) is a front view, (c) is a right-side view, (d) is an upper view, (e) is a bottom view, and (f) is a rear view.

FIG. 3 shows external views of a bone conduction speaker and a laryngophone connected to the connecting equipment shown in FIG. 1; (a) presents a front view, a side view, and a rear view, respectively, of a bone conduction speaker, and (b) presents a front view, a side view, and a rear view, respectively, of a laryngophone.

FIG. 4 is a block diagram of the connecting equipment shown in FIG. 1.

FIG. 5 is a configuration view that shows the entire handset of the present invention, along with related equipment and devices to be connected to the connecting equipment of the handset.

FIG. 6 is a block diagram of a communication system connected to the connecting equipment shown in FIG. 1.

### BEST MODES FOR CARRYING OUT THE INVENTION

Embodiments of the present invention will now be described with reference to the figures.

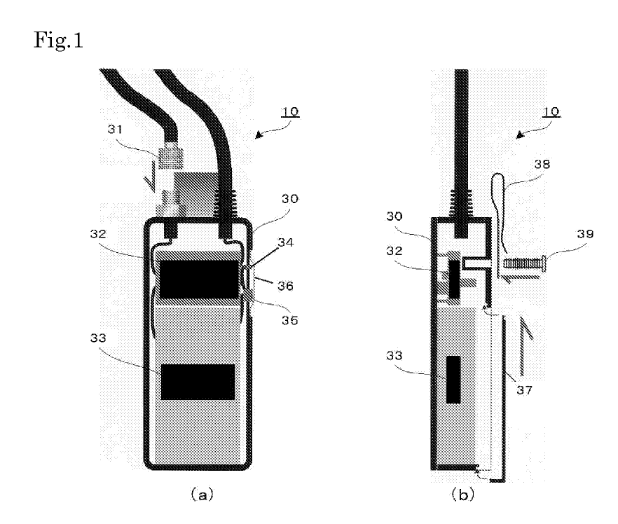

FIG. 1 presents structural views of the connecting equipment of the handset of one embodiment of the present invention; (a) is a cross-sectional view from the front and (b) is a cross-sectional view from the right side.

As shown in FIG. 1, the connecting equipment 10 is waterproof and is designed to be a watertight type that satisfies either waterproof grade 6 (IP class 6) as set forth in JIS C0920 (Degrees of protection provided by enclosures) or the standard of IEC (International Electrotechnical Commission) 529 (Degrees of protection by enclosures), and that will not allow water of a strong, continuous current, jet flow from any direction to enter inside. The connecting equipment 10 is provided with
an amplifier that executes impedance matching with a bone conduction speaker, and drives the bone conduction speaker and outputs voice signals, and
an impedance-matching preamplifier that amplifies transmitted voice signals of voice vibrations picked up by a laryngophone and that optimizes frequency characteristics by a frequency-compensation circuit, and
   has a built-in substrate 32, in which electronic circuits are implemented for making calls via an outside communication system. In this embodiment, the electronic circuits are incorporated in a substrate 32 that is approximately 28 mm×18 mm×13 mm in size. In addition, a battery box 33 is integrated so as to supply power to electronic circuits that are incorporated in the connecting equipment 10, which enables the use of replaceable primary batteries as well as secondary batteries. A charging terminal (not shown) is provided so that the secondary batteries can be recharged from a charging apparatus that has external connections. The size of the battery box 33 is approximately 52 mm×28 mm×13 mm.

The current standards for waterproof grades include: grade 0, no waterproofing; grade 1, drip-proof type I that is free from detrimental effects by water drops falling straight down; grade 2, drip-proof type II; grade 3, rain-proof type; grade 4, splash-proof type; grade 5, waterjet-proof type; grade 6, the watertight type of this embodiment, which will not allow water of a strong, continuous-current waterjet flow from any direction to enter inside; grade 7, waterproof type; grade 8, a submersible type that can be used regularly submerged in water under specified conditions; and, in addition to the foregoing, a moisture-proof type.

Furthermore, it is desirable for a device to be dustproof as well as waterproof. The current standards for dustproof grades include: grade 0, no dustproofing; grades 1 to 4, which are drip-proof type I, drip-proof type II, rain-proof type, and splash-proof type, respectively; grade 5, dust-tight type that prevents entry of coarse particulates (dirt or dust that is 75 μm or less in diameter) that can hamper proper operation or safety of a device; grade 6, dustproof type that allows no entry of any coarse particulates.

The connection with the bone conduction speaker and the laryngophone uses a multiconductor cable, removably affixing the waterproof plug 31 to the connecting equipment 10, ensuring ease of fitting and service. To ensure a waterproof structure, a plastic cover 36 covers both (1) a push switch 35 that is configured by implementing a tact switch or a membrane switch at the substrate, and (2) an LED 34 that indicates when the power is on. The battery box 33 is also waterproofed, and silicone rubber is applied on the periphery of the housing 30 that receives a sliding battery cover 37. A clip 38 is attached to the connecting equipment 10 for mounting that equipment. The clip 38 is threadably mounted by inserting a screw 39 into a screw hole in the housing 30, and thus the clip 38 also is removable. The housing 30, into which the substrate 32 having the electronic circuits is mounted, is assembled by pressure bonding or the like, while the waterproofing of the property housing 30 is maintained by using silicone rubber or the like.

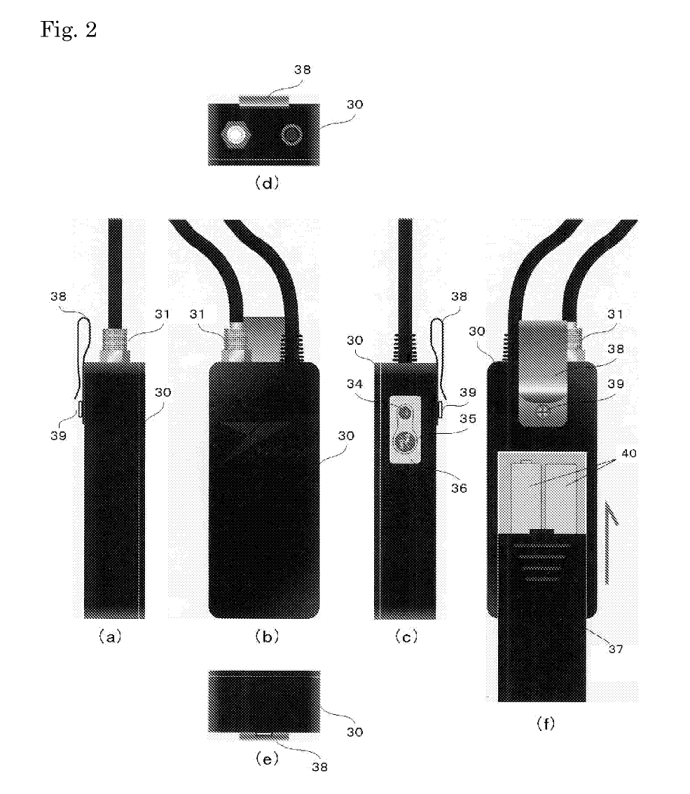

FIG. 2 presents external views of the connecting equipment shown in FIG. 1; (a) is a left-side view, (b) is a front view, (c) is a right-side view, (d) is an upper view, (e) is a bottom view, and (f) is a rear view. As described above, a multiconductor transmission cable, used for receiving and transmitting voices via the laryngophone and the bone conduction speaker, respectively, is detachably mounted on the connecting equipment 10 by using the screw-in waterproof plug 31. The connecting equipment 10 and the communication system that has external connections are connected by another transmission cable, and a connector that connects the connecting equipment 10 and the communication system is provided on the communication system. The connecting equipment 10 and the communication system are also connected using a multiconductor cable. It is possible to provide versatility by mounting, on the connecting equipment 10, a connector that connects the connecting equipment 10 and the communication system via a transmission cable, so as to enable that connecting equipment 10 to connect with various types of communication systems.

As shown in FIG. 2(c), a waterproof push-type power switch 35 is located on the right side of the connecting equipment 10, with the ON/OFF of the LED 34 showing whether the unit is on or off. As shown in FIG. 2(f), replaceable batteries that supply power to the electronic circuits inside the connecting equipment 10 are provided in the back of the connecting equipment 10, being covered by a waterproofed sliding battery cover 37 on whose backside urethane is affixed so as to prevent the batteries from coming loose. Although the example of FIG. 2 shows a configuration using two battery cells (two 3A batteries) in order to minimize the size of the handset, rechargeable batteries such as Li-ion batteries can be used as well. A dedicated or general-purpose charging apparatus provided separately can be used to charge the batteries, or they can be charged from a power source of the communication system superimposed on the transmission cable. On the upper portion of the battery cover 37, a clip 38 that is threadably mounted by a screw 39 is detachably provided so that the unit can easily be clipped on clothes, a belt, and the like.

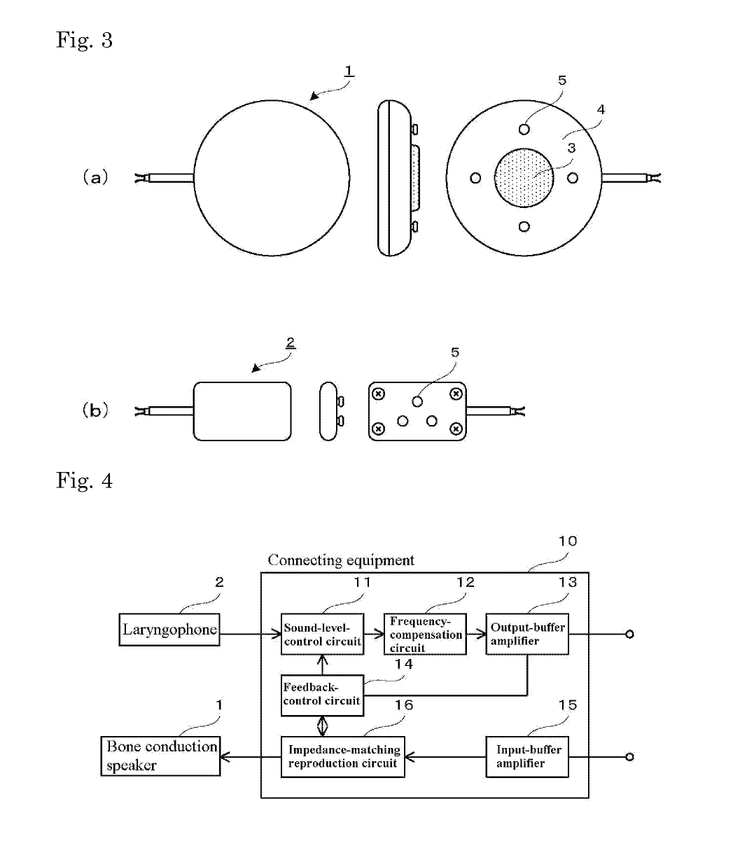

FIG. 3 shows external views of a bone conduction speaker and a laryngophone connected to the connecting equipment shown in FIG. 1; (a) presents a front view, a side view, and a rear view, respectively, of a bone conduction speaker, and (b) presents a front view, a side view, and a rear view, respectively, of a laryngophone.

The bone conduction speaker 1 shown in FIG. 3(a) uses PZT (piezo element) ceramic materials for its vibrating body, which is configured as a waterproofed receiver. The bone conduction speaker 1 is covered by a cover 4 for waterproofing and other protection, except for the contact surface 3 that directly contacts the PZT ceramic vibrating plate and allows it to contact the temporal region and the like of a user. The contact surface 3 that is to contact the temporal region is not limited to having a smooth surface. It can instead make contact via a number of points, though for safety considerations in an operating environment when mounting the bone conduction speaker 1 on a helmet or the like it is best that the contact be made via a surface or multiple contact points. The bone conduction speaker 1 is provided with a fastener 5 (projections) and is mounted by having the projections such that they either fit holes in an inner protection band or the like that maintains a helmet on a user's head or fit a fastener on the receiving side (not shown).

The laryngophone 2 shown in FIG. 3(b) is a waterproofed microphone using PZT ceramic materials for its vibrating body, like the bone conduction speaker 1. The laryngophone 2 is provided with a fastener 5 (projections), also like the bone conduction speaker 1, and is mounted having the projections such that they either fit holes on a support belt (chin strap) of a helmet, or fit a fastener on the receiving side (not shown). Inasmuch as the laryngophone directly contacts the skin of the neck and so on, the contact surface of the laryngophone 2 is preferably covered by a material made of pure medical-grade silicone. The bone conduction speaker 1 and the laryngophone 2 should be water-repellent types such as a waterproof grade-7 type that is free from detrimental effects when being soaked in water under a specified pressure and for a specified time, or a submersible grade-8 type that can be used by a person regularly being submerged in water under specified conditions.

FIG. 4 is a block diagram of the connecting equipment shown in FIG. 1, and wherein voice signals passing through the multiconductor transmission cable from the laryngophone are (1) input into a level-control circuit 11 controlled by a feedback-control circuit 14—including a level-detecting circuit and the like—that configures AGC (automatic gain control), (2) provided—by a frequency-compensation circuit 12 that uses a BPF (band-pass filter) and the like—with (a) audio-frequency characteristics in which articulation and the like are optimized, and (b) a frequency band conforming to the transmission standard of communication systems of specified low-power radio equipment and the like that have external connections, (3) transformed into an appropriate impedance, such as 600 ohm or the like, by an output buffer amplifier 13, and (4) input into a modulation voice-input unit (not shown) of the communication system through the multiconductor transmission cable.

Reproduced voice signals from a voice-output unit (not shown) that receives and demodulates external high-frequency radio signals by the communication systems, in turn, (1) go into an input buffer amplifier 15 through the multiconductor transmission cable, (2) are input into an impedance-matching reproduction circuit 16, and (3) by driving the bone conduction speaker 1, reproduce the voices through the multiconductor transmission cable.

At that time, feedback control is conducted by inputting part of the voice output into the feedback-control circuit 14, and when received signals exceed or do not reach an appropriate level, the sound volumes of both parties are controlled—by control signals to the level-control circuit 11—at an appropriate level according to the voices of both parties. Further, depending on the communication method and the like, an echo-cancellation circuit can be incorporated into the feedback-control circuit 14 if delays occur in receiving and transmitting voices.

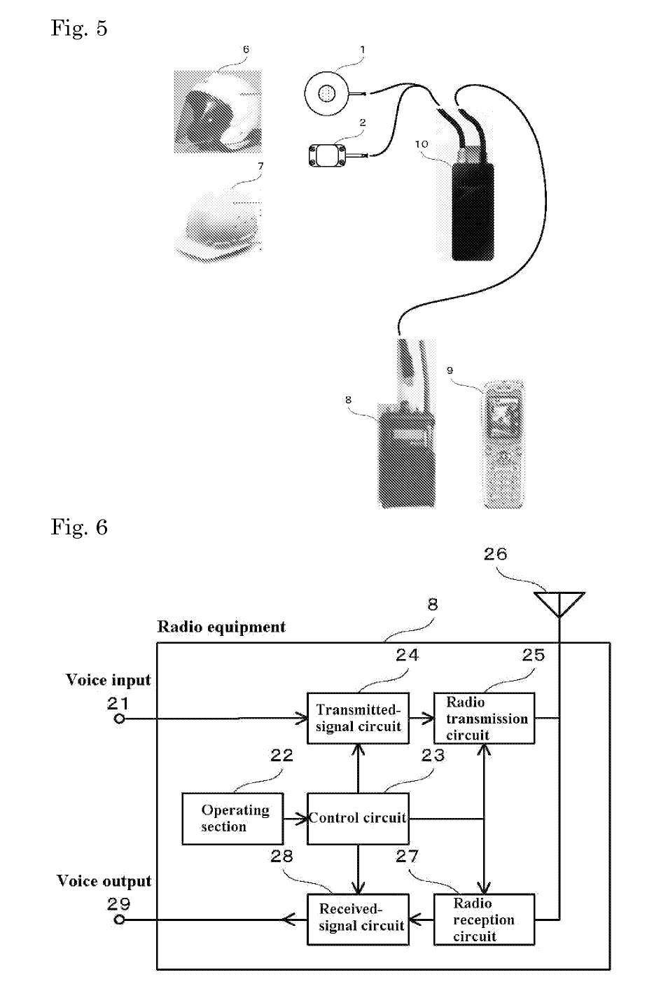

FIG. 5 is a configuration view that shows the entire handset of the present invention, along with related equipment and devices to be connected to the connecting equipment of the handset. As shown in FIG. 5, the connecting equipment 10, in which electronic circuits for voice input and voice output are incorporated, connects the bone conduction speaker 1 and the laryngophone 2 with radio equipment 8 through a multiconductor transmission cable, transmitting voice signals to the bone conduction speaker 1, amplifying voice vibrations picked up by the laryngophone 2 as electronic voice signals, and connecting—with impedance being matched—to the voice-input unit of the radio equipment 8, which has a multiconductor connector. For the radio equipment 8, there can be used a radio and the like of an unlicensed specified low-power level not exceeding 10 mW as a radio station, as provided for by the Radio Law of Japan (a radio station specified by the applicable ordinance, in accordance with Article 4, paragraph (3) of the Radio Law), having external connections using radio waves of carrier frequencies such as 421 MHz or 440 MHz). As a substitute for the radio equipment 8 of specified low-power, a mobile telephone 9 can be used, which can extend the range of communication.

When wearing either a helmet such as a full-face helmet 6 that is used when riding on a two-wheel vehicle such as a motorcycle or the like, or a helmet 7 that is used at construction sites and the like, a sack-like pocket is provided for an inner cap (not shown) that is worn under the helmet 6 or 7 at the user's temporal-region area that the bone conduction speaker 1 touches, ensuring ease of service and of fitting by placing the bone conduction speaker 1 in the pocket between that of and the inner wall of the helmet. As shown in FIG. 3, the bone conduction speaker 1 can be mounted—using a fastener—on the inner protection band of a work helmet or the like. The laryngophone 2 can be mounted by using holes opened on a support belt (chin strap) of the helmet, or by using a fastener 5 (projections) that fits fastener holes on the receiving side. Or a sack-like pocket can be provided where the laryngophone 2 is placed on the support belt of the helmet, ensuring ease of fitting and service, similar to the bone conduction speaker 1.

Depending on the material(s) used to make the support belt, “howling” (i.e., acoustic feedback) can occur whereby the voice output from the bone conduction speaker 1 is received by the laryngophone 2 that is mounted on the support belt. In such case, the howling can be stopped by incorporating an echo-canceling circuit into the connecting equipment 10. Or a foam buffer sheet that blocks or attenuates acoustic transmission can be provided on a part of the support belt between the helmet 6 or 7 and at the position where the laryngophone 2 is mounted, so as to stop the howling.

FIG. 6 is a block diagram of radio equipment (communication system) 8, wherein the radio equipment 8 comprises an antenna 26, a radio reception circuit 27 that receives radio signals via the antenna 26, a received-signal circuit 28 that converts high-frequency signals received at the radio reception circuit 27 into audio-band signals using heterodyne detection and the like and then amplifying the signals and outputting them, a voice-output unit 29 for outputting received voice signals to the bone conduction speaker 1, an operating section 22 that switches between sending and receiving by using a PTT (push-to-talk or press-to-talk) system, a computer-control section (a control circuit 23) that controls the entire operation of the radio equipment 8, a voice-input unit 21 that inputs—for transmission—voice signals from the laryngophone 2 (a multiconductor connector is used for the voice-input unit 21 and the voice-output unit 29, which are connected to the connecting equipment 10 through a multiconductor transmission cable), a transmitted-signal circuit 24 that generates modulated waves of FM modulation or PM modulation audio signals and the like, and a radio transmitting circuit 25 that (1) amplifies the modulated waves, (2) sets the output at, for example, a level not exceeding 10 mW (such as 1 mW output) to meet the specifications of the specified low-power radio equipment, and (3) transmits the modulated waves via the antenna 26.

With radio equipment that uses the PTT system, pushing the transmitting switch of the operating section 22 as depicted in FIG. 6 allows a user to respond to the other party so as to have a conversation using the voice sounds input from the laryngophone 2. While holding down the transmitting switch, the voice sounds that are input from the laryngophone 2 are input into the transmitted-signal circuit 24 of the radio equipment 8 through the level-control circuit 11 and then to the output buffer amplifier 13 of the connecting equipment 10, and they are then transmitted as radio signals through the radio transmission circuit 25 and the antenna 26. By releasing the transmitting switch, the radio signals, into which the voice signals are modulated from the voice signals of the other party—go through an antenna 26, a radio reception circuit 27, and a received-signal circuit 28 of the radio equipment 8—into an input buffer amplifier 15 as voice signals, and, through the multiconductor transmission cable, drive the bone conduction speaker 1, using an impedance-matching reproduction circuit 16, which makes it possible to reproduce voices so as to have a conversation with a distant person.

Because it is highly probable that one hand of a user needs to be used to operate the radio equipment of the PTT system, and that use of such radio equipment of the PTT system might be limited due to the adverse conditions in a workplace environment, radio equipment of a full-duplex system that allows two-way simultaneous communications via separate frequencies and channels for sending and receiving is normally used in such work environments as construction sites and the like. However, the present invention enables both hands to be available for work, because the user does not have to push a PTT switch. For the radio equipment 8, various types of radio equipment (such as a PHS, a professional MCA radio system of a multichannel access system retrieving free channels using carrier sensing, and a radio IP phone that uses wireless-LAN access points) are available for use instead of a mobile telephone 9, and those types will be used as an aeronautical radio where there are ambient noises such as the sounds of jet airplanes and also used for various other purposes, such as for communications by police or fire personnel, marine communications, military communications, and so on.

Although in the embodiment described above, connectors using multiconductor transmission cables are used to connect connecting equipment 10 and radio equipment 8, wireless connections between connecting equipment 10 and radio equipment 8 also are available. For example, both the connecting equipment 10 and the radio equipment 8 can be provided with an infrared communication circuit (not shown) to make wireless connecting equipment. In such a case, both a circuit to modulate infrared rays and a light-emitting unit (not shown) can be provided in the rear part of the output buffer amplifier 13 on the voice-output side of the laryngophone 2 shown in FIG. 4. Moreover, a demodulator circuit and a light-receiving unit (not shown) can be provided in the front part of the input buffer amplifier 15 on the voice-input side of the bone conduction speaker 1, and the modulator circuit and demodulator circuit can be controlled by an infrared-communications control unit (not shown) by using, for example—as the standard for infrared communication—the standard set by the IrDA (Infrared Data Association.

In addition, for the corresponding radio equipment 8, a light-receiving unit and a demodulator circuit (not shown) can be provided in the foregoing part of the transmitted-signal circuit 24 on the voice-input unit 21 side shown in FIG. 6, and a modulator circuit and a light-emitting unit (not shown) can be provided at the rear of the received-signal circuit 28 on the voice-output unit 29, wherein the demodulator circuit and modulator circuit are controlled by an infrared communication control unit (not shown).

As described above, connecting wirelessly between the connecting equipment 10 and the radio equipment 8 allows the connecting equipment 10 and the radio equipment 8 to connect over a larger distance between them, and eliminates the need for a user to wear the equipment 8 on his or her body, which expands the scope of operation and increases the compatibility of the device with various work environments.

The above-mentioned example describe wireless communications using infrared communication between the connecting equipment 10 and the radio equipment 8, and it goes without saying that it also is possible to provide short-distance wireless communication between the connecting equipment 10 and radio equipment 8 in accordance with the Bluetooth™ standard and the like, using radio waves.

Furthermore, the connecting equipment 10 can be integrally incorporated into the radio equipment 8, with suitable configurations being adopted according to the operating and work environments.

### INDUSTRIAL APPLICABILITY

The handset using the bone conduction speaker and the laryngophone according to the present invention can be applied in various fields and forms, not limited to the above-mentioned applications. For example, a speaker panel can be configured to allow the vibrator of the bone conduction speaker to have contact with an advertisement poster so as to make the poster itself a vibrating plate, or the bone conduction speaker can be used as a stethoscope. The applications of the sound-making panel can be broadened across various products and forms other than posters for advertising, such as photos, pictures, illustrated books, greeting cards, and the like.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A handset, comprising,
a bone conduction speaker that uses a ceramic piezo element for transmitting a voice by utilizing bone conduction sound;
a laryngophone that uses a ceramic piezo element for picking up voice vibrations around a user's throat; and
connecting equipment that detachably connects said bone conduction speaker and said laryngophone, processes signals, and that includes a transmission line that transmits signals that are sent and received for calls.

2. The handset according to claim 1, wherein said bone conduction speaker and said laryngophone use PZT (piezo element) ceramic material and have a waterproof structure that satisfies either the International Protection Code (IP Code) waterproof standard as set forth in JIS C0920 (Degrees of protection provided by enclosures) or the standard of IEC (International Electrotechnical Commission) 529 (Degrees of protection by enclosures).

3. The handset according to claim 1, wherein said connecting equipment comprises,
a sound-level control unit (circuit) that amplifies and adjusts the level of signals of said laryngophone;
a frequency-compensation circuit that defines the transmission-frequency characteristics of signals,
an output buffer amplifier that connects with the voice-input unit of a communication system that has external connections;
an input buffer amplifier that connects with the voice-output unit of said communication system;
an impedance-matching reproduction circuit that achieves impedance matching by outputting by reproducing voice signals to said bone conduction speaker; and
a feedback-control circuit that detects the level of voice signals so as to obtain the appropriate signal level.

4. The handset according to claim 1, wherein said bone conduction speaker is detachably contained in a sack-like portion that is in the inner cap of a helmet and that is mounted between the head of a user and the inner wall of the helmet or is detachably mounted on an inner protection band of the helmet by a fastener provided on said bone conduction speaker, and
said laryngophone is detachably contained in a sack-like portion on the support belt of the helmet or is detachably mounted on said support belt by a fastener that is on said laryngophone.

5. The handset according to claim 3, wherein the sending and receiving of signals between said connecting equipment and said communication system are executed by wireless communications that use light-wave transmission by infrared communication or that use electromagnetic waves.

6. The handset according to claim 3, wherein said connecting equipment is integrally incorporated into said communication system.

7. The handset according to claim 3, wherein said connecting equipment is provided with a rechargeable secondary battery that supplies power to an internal circuit of said connecting equipment, and that is rechargeable by a power source that supplies power through a transmission cable that is connected to said communication system, or by a power source that is supplied from externally connected charging equipment.

8. The handset according to claim 4, wherein said support belt is provided with a foam buffer sheet that blocks or attenuates acoustic transmission between said helmet and the aforementioned sack-like portion that contains said laryngophone.

9. The handset according to claim 1, wherein said bone conduction speaker is attached to a display panel and is used as a speaker to vibrate said display panel.
